(19) United States
(12) Patent Application Publication
(10) Pub. No.: US 2008/0062413 A1
(43) Pub. Date: Mar. 13, 2008

(54) Apparatus and Method for Characterizing a Light Source

(76) Inventors: Ian Ashdown, British Columbia (CA); Marc Salsbury, British Columbia (CA)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/774,606

(22) Filed: Jul. 8, 2007

Related U.S. Application Data
(60) Provisional application No. 60/819,328, filed on Jul. 7, 2006.

(51) Int. Cl. G01J 1/42

(52) U.S. Cl. 356/218

(57) ABSTRACT

The present invention provides an apparatus and method for characterizing the photometric and/or colourmetric properties of a light source. The apparatus comprises a detector system which generates data indicative of at least spectroradiometric data for at least a portion of the light emitted by the light source. The apparatus further comprises a manipulation stage configured to control the relative position between the detector system and the light source. In addition, the apparatus comprises a control and processing system configured to control operation of the detector system, operation of the manipulation stage and record the data and the relative position of the detector system associated therewith. The control and processing system is further configured to process the collected data for determination of the photometric and/or colourmetric properties of the light emitted by the light source.

### CROSS-REFERENCE TO A RELATED APPLICATION

This application claims the benefit of U.S. Provisional Application Ser. No. 60/819,328, filed Jul. 7, 2006, which is hereby incorporated by reference in its entirety.

### FIELD OF THE INVENTION

The present invention pertains to spectroradiometry and in particular to an apparatus and method for determining spatially resolved photometric and/or colourmetric properties of a light source.

### BACKGROUND

A luminaire can be more effective if the characteristics of light sources and optical systems of the luminaire are adequately matched. Adequate matching requires knowledge of the spectroradiometric properties of a light source and more importantly how the spectroradiometric properties are perceived by an observer. Generally, knowledge of light-emitting characteristics of a luminaire has a number of important uses, which can include quality control. The following publications describe systems or methods which can be used for measuring radiometric properties of light sources under operating conditions.

For example, U.S. Pat. No. 3,931,515 describes an optical detecting, tracking and indicating apparatus for producing a target angular position signal independent of target intensity. It includes a photoconductive detector element which has four outer electrodes disposed in a rhombic pattern and a centrally disposed inner electrode. A pair of quadrantly phased, alternating current primary bias signals are coupled to oppositely disposed electrode pairs. The central electrode is coupled through a load impedance and a source of a secondary bias signal at a second frequency differing from the first bias signal frequency. A composite signal including both phase and frequency components of the primary bias signals appears in the output. The composite signal varies with target position and intensity. A secondary output signal at the second frequency varies only with intensity. A divider circuit divides the composite signal by the secondary signal to produce an output signal which varies only in accordance with the relative position of radiant energy impingent on the photoconductor.

U.S. Pat. No. 5,253,036 describes a near-field goniophotometric apparatus and method for measuring the three-dimensional near-field distribution of luminous flux surrounding a light source. The apparatus incorporates an imaging photometer mounted on a rotatable arm. The photometer is designed to measure the four-dimensional luminance field surrounding a volumetric light source. A control mechanism is provided to position the arm and to rotate the light source relative to the arm. The method facilitates prediction of the illuminance or irradiance at a point on a plane from the luminance field measurements.

U.S. Pat. No. 5,521,852 describes a method and system for designing a lighting installation. The system includes a processor for executing the method, which includes generating lighting area input data signals based on selected parameters associated with a lighting area, and generating luminaire input data signals based on selected parameters associated with a luminaire. The method also includes processing the lighting area input data signals to obtain a lighting area factor, and processing the luminaire input data signals to obtain a photometry factor. The method also includes processing the lighting area factor and the photometry factor to determine a light level value in the lighting area, and generating a light level output signal based on the light level value determined. The system and method further include a system and method for manipulating data three-dimensionally in a spatial view on a video monitor.

U.S. Pat. No. 5,949,534 describes a gonioradiometric scanning apparatus and method for measuring the near and/or far field radiation pattern of radiating optical sources such as laser diodes (LD), light-emitting diodes (LED), optical fibers, flat panel displays, and luminaires. The scanning apparatus incorporates a deflector for selecting an azimuth angle through the optical source to be measured, a rotating apparatus which collects light while scanning about the source, an optical commutator, and a detector. The rotating apparatus comprises a cylindrical hub and an optical collector using either an optical fiber or a train of reflectors, such as mirrors or retro-reflectors. The optical collector provides a means for both collecting light and for directing the beam emanating from the deflector to a place opposite the detector at which optical commutation occurs. The reflector optical train, when employed, folds the optical path and increases the effective radius of measurement, so that large radius scans can be obtained in an instrument with compact geometry. Depending on the source geometry and the effective optical path, the light collection can be either in the near field or the far field of the source radiation pattern. For the case of the far field radiation pattern, it will also be possible to measure the near field radiation patterns by imaging the source onto the light collection surface.

U.S. Pat. No. 6,788,398 describes a method and apparatus for rapid measurements of far-field radiation profiles having a large dynamic range from an optical source. The apparatus can include a collector coupled to a rotating hub so that the rotation of an entrance to the collector defines a plane, a detector coupled to receive light captured at the entrance to the collector, and detector electronics having a programmable gain coupled to receive a signal from the detector. The apparatus may include a rotatable entrance mirror for reflecting light from the optical source into the plane of the entrance of the collector. The optical source may be fixed relative to the plane of the entrance of the collector. The optical source may be rotatable in the plane defined by the entrance of the collector. In order to obtain a large dynamic range, far-field data from the optical source is taken at a number of gain settings of the detector electronics and a compiled far-field radiation profile is constructed. Characterizing parameters for the optical source, such as fiber parameters for an optical fiber, can be calculated based on the compiled far-field radiation profile.

U.S. Pat. No. 6,983,547 describes a goniometer which includes a base, a compound member supported by the base, a light-directing element operably mounted on the compound member, optically connected to a coherent light source, and disposed toward an optical filter, a first actuator disposed along a first axis and operably coupled to the base for translating the light-directing element along a first arcuate path disposed in a first plane; and a second actuator disposed along a second axis and operably coupled to the compound member for translating the light-directing element along a second arcuate path disposed in a second plane, wherein the first plane is orthogonal to the second plane, and wherein the first and second axes are co-planar, for directing coherent light at an angle that is normal to the optical filter.

United States Patent Application Publication No. 2005/0146713 describes an apparatus for measuring the optoelectrical properties of an organic light-emitting device (OLED) comprising a platform, a goniometer, a three-axis moving device and a computer. The goniometer is disposed on one side of the platform and an OLED is disposed on the goniometer. The three-axis moving device is disposed on another side of the platform. The photo-detector is disposed on the three-axis moving device with the photodetector toward the OLED on the goniometer. The goniometer, the three axis moving device and the photodetector are connected to the computer.

Further, also I. Ashdown in “Making Near-Field Photometry Practical”, IESNA Conference Paper: May, 1997, describes the measurement of radiometric characteristics of light sources.

There is a need for a new apparatus for determining the photometric and colourmetric properties of a light source.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus and method for characterizing a light source. In accordance with an aspect of the present invention, there is provided an apparatus for determining properties of light emitted by a light source, the apparatus comprising: a detector system for generating data indicative of at least spectroradiometric data for at least a portion of the light emitted by the light source, a manipulation stage configured to control relative position between the detector system and the light source; and a control and processing system configured to control operation of the detector system and operation of the manipulation stage, the control and processing system further configured to record the data and the relative position of the detector system and the light source associated therewith, the control and processing system configured to process the data for determination of the photometric or colourmetric properties of the light emitted by the light source.

In accordance with another aspect of the present invention, there is provided a method for determining properties of light emitted by a light source, the method comprising the steps of: disposing and aligning the light source relative to a coordinate system; positioning a detector system at a sensor position distal to the light source thereby defining a relative position and orientation between the detector system and the light source, the detector system generating at least spectroradiometric data of at least a portion of the light emitted by the light source; acquiring spectroradiometric data from the detector system; manipulating the spectroradiometric data to produce photometric or colourmetric data indicative of the acquired spectroradiometric data.

### BRIEF DESCRIPTION OF THE FIGURES

FIG. 1 schematically illustrates an apparatus for characterizing a light source according to one embodiment of the present invention.

FIG. 2 illustrates a portion of a user interface according to one embodiment of the present invention.

FIG. 3 is a photograph of a manipulation stage of the apparatus for characterizing a light source according to one embodiment of the present invention.

FIG. 4 is another photograph of the manipulation stage of FIG. 3.

FIG. 5 is a photograph of a probe support for the apparatus for characterizing a light source according one embodiment of the present invention.

FIG. 6 is a photograph of a front view of a probe for the probe support of FIG. 5.

FIG. 7 is a photograph of a prototype set-up of a manipulation stage and probe according to an embodiment of the present invention.

### DETAILED DESCRIPTION OF THE INVENTION

Definitions

The term “light-emitting element” is used to define a device that emits radiation in a region or combination of regions of the electromagnetic spectrum for example, the visible region, infrared and/or ultraviolet region, when activated by applying a potential difference across it or passing a current through it, at least in part because of electroluminescence. A light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, for example, a LED die, and can equally be used to define a combination of the specific device that emits the radiation together with a housing or package within which the specific device or devices are placed.

The term “manipulation stage” is used to refer to an apparatus which has one or more mechanical degrees of freedom. Each degree of freedom can be translational or rotational or other predetermined, arbitrary type movement, for example. For example, a manipulation stage can be a goniometer, Eulerian cradle or the like. A manipulation stage may be either manually or automatically operated or both, for example.

As used herein, the term “about” refers to a ±10% variation from the nominal value. It is to be understood that such a variation is always included in any given value provided herein, whether or not it is specifically referred to.

Unless defined otherwise, all technical and scientific terms used herein have the same meaning as commonly understood in the art to which this invention belongs.

The present invention provides an apparatus and method for characterizing the photometric and/or colourmetric properties of a light source. The apparatus can be used for spatially or directionally resolved determination of photometric and/or colourmetric properties of a light source. Photometric and/or colourmetric properties of the light source can include integral, spatially or directionally resolved correlated colour temperature (CCT), colour rendering index (CRI), luminance (L), chromaticity (x,y) or (u,v), as well as other CIE metrics, for example. It is noted that alternative colour space representations are known and may be equally used by the present invention to represent the photometric and/or colourmetric properties of a light source.

The apparatus comprises a detector system which generates data indicative of at least spectroradiometric data for at least a portion of the light emitted by the light source. The apparatus further comprises a manipulation stage configured to control the relative position between the detector system and the light source. In addition, the apparatus comprises a control and processing system configured to control operation of the detector system, operation of the manipulation stage and record the data and the relative position of the detector system associated therewith. The control and processing system is further configured to process the collected data for determination of the photometric and/or colourmetric properties of the light emitted by the light source.

The apparatus according to the present invention can be used for manipulating the relative positioning between a light source and detector system thereby enabling spatially and directionally resolved sampling of at least the spectroradiometric properties of the light source to obtain photometric and/or colourmetric properties of the light emitted by the light source. In one embodiment, the apparatus can enable the determination of averages or integral values of respective photometric and/or colourmetric properties over desired solid angles.

In one embodiment of the present invention, the light source is affixed to the manipulation stage and the manipulation stage can be positioned at a desired distance from and desirably aligned relative to the detector system. Manipulation of the orientation of the light source relative to the detector system can be accomplished by adequately controlling the manipulation state, which may be controlled manually, via actuators or a combination thereof. The manipulation stage and the actuators can be controlled via a control and processing system. In one embodiment, the detector system is affixed to the manipulation stage.

The control and processing system controls the operation of the detector system and may optionally be configured to activate and maintain the light source at desired operating conditions. Control of the detector system can comprise actions such as (de)activation, detector system calibration, sensitivity selection, optical alignment, optical focusing, optical collimation and the like.

The detector system, the manipulation stage, the control and processing system and the light source can be adequately interconnected using a number of wired or wireless interconnect systems for control and supply of power. The interconnect system can be used to transmit analog or digital signals, wherein respective wiring or cables may be shielded, specifically to provide adequate signal-to-noise ratios for analog or digital signal transmission therewith.

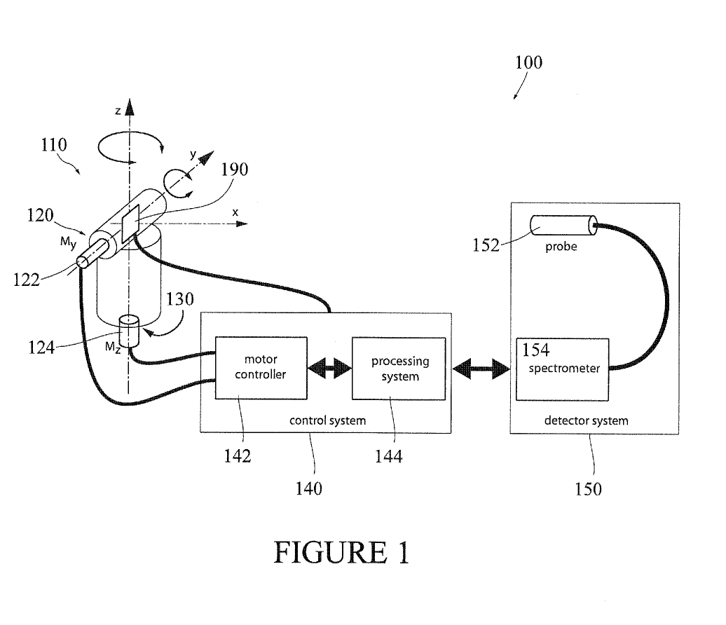

FIG. 1 schematically illustrates an apparatus 100 according to one embodiment of the present invention. The apparatus comprises a manipulation stage 110 with two rotational degrees of freedom for manipulating the orientation of light source 190, a detector system 150 configured to collect at least spectroradiometric data of the light source. The apparatus further comprises a control system 140 which includes a motor controller 142 and a processing system 144. The motor controller 142 is configured to control operation of the manipulation stage 110 and the processing system 144 is configured to process the spectroradiometric data for conversion thereof into photometric and/or colourmetric data.

Having further regard to FIG. 1, the motor controller 142 controls the actuators or motors identified as M_{y} 122 and M_{z} 124 in accordance with instructions received from the processing system 144. The motor controller 142 can report status information regarding the condition or position of the actuators or motors 122 and 124 to the processing system 144.

The detector system 150 includes one or more detectors which enable the collection of at least spectroradiometric data representative of the light emitted by the light source. The control system 140 is operatively connected to the detector system 150 with which it can exchange control and data signals. The detector system can provide information regarding acquired spectroradiometric data such as the spectral power distribution (SPD) of the sensed light or can be configured to substantially directly provide photometric and/or colourmetric data.

Detector System

The detector system samples at least the spectroradiometric properties of the light source and the detector system, or the processing system, can manipulate the acquired spectroradiometric data into photometric and/or colourmetric data. The detector system can be configured in a number of different ways including a probe, multi-channel detector, a spectrometer or the like, for example.

In one embodiment, the detector system comprises a detector formed from one or more detector elements which can be configured linearly or in an areal matrix-like fashion or in another configuration as would be known in the art, for collecting data indicative of characteristics of the light output of the light source.

In one embodiment of the present invention, the detector system comprises a probe and a detector which are interconnected by an adequate optical or optoelectrical connection such as an optical-fiber or a reflector network, for example. The connection allows movement of the probe relative to or independent of the detector. In this configuration, the probe provides for the collection of at least a portion of the light emitted by the light source and the detector enables the detection of this collected light.

It is understood that the detector and the probe can be combined into a single modular unit. For example, they can be structurally integrated or can be mounted together on the manipulation stage. Alternatively, a probe may not be required for certain types of detectors.

In one embodiment of the present invention, the detector system is configured to directly acquire photometric and/or colourmetric data representative of the light source. In this embodiment, the detector system can comprise adequate filter elements which are configured to appropriately filter the light output of the light source thereby obtaining data representative of the photometric and/or colourmetric properties of the light source. The determination can be accomplished in a number of different ways, for example, by filtering the light with a set of adequate filter elements and determining the integral intensity of the light transmitted through each filter element or by determining, with adequate resolution, the spectral power distribution (SPD) of the light and processing the SPD with a set of adequate filter functions in a processing unit such as a computer, for example.

In one embodiment, the present invention can spatially resolve spectroradiometric as well as the photometric properties. For example, spectroradiometric and photometric properties can be determined within desirably narrow solid angles for coordinates relative to the light source. Generally, the spectral sensitivities of the filter elements as well as modeled spectral sensitivities expressed by the filter functions need to sufficiently accurately mimic the spectral sensitivity of the desired vision model used to describe the photometric and/or colourmetric properties of the light. As discussed above, there exist a number of standardized vision models. For example, the modeled spectral sensitivities of the filters in embodiments of the present invention can be CIE 1931 RGB colour matching functions.

In one embodiment of the present invention, the detector system comprises a collimation system including, for example, one or more slits or apertures for controlling the light receiving solid angle and for collimating light. The detector system can comprise an adequately shaped end of an optical fibre or a bundle of optical fibres, for example. The detector may comprise one or more other optical elements which provide for the collection of at least a portion of the light emitted by the light source. For example an optical element can be a reflector, concentrator or other format of optical element which provides the desired functionality as would be readily understood by a worker skilled in the art.

Manipulation Stage

The manipulation stage is used to reproducibly rotate, translate, or translate and rotate the detector system or light source which is adequately affixed to the manipulation stage, in order to adjust the relative angular orientation and relative position between the detector system and the light source. The manipulation stage is configured to align the light source relative to the detector system, by either orienting or moving the light source, the detector system or both.

In one embodiment of the present invention, the manipulation stage has two or more degrees of freedom for orienting and positioning of the light source relative to the detector system. As would be readily understood, the extent of movement along each degree of freedom may be limited by the type of manipulation stage.

In one embodiment of the present invention, the a first manipulation stage with at least one degree of freedom enables the manipulation of the position or orientation of the light source and a second manipulation stage with at least one degree of freedom enables the manipulation of the position or orientation of the detector system.

In one embodiment of the present invention, the manipulation stage comprises one or more actuators, precision motors or the like to enable the movement of the manipulation stage about a degree of freedom. For example, the manipulation stage can comprise one or more motorized positioning and control devices such as those provided by Newport Corporation or Huber Diffraktionstechnik GmbH & Co. KG. The precision motors, actuators and the like can be connected to and be suitably controlled by the control and processing system.

In one embodiment of the present invention, the manipulation stage comprises a mounting stage for affixing a light source. The manipulation stage has at least one rotational degree of freedom for orienting the mounting stage at a desired first angle about a respective first axis of rotation and another degree of freedom for orienting the mounting stage at a desired second angle about a respective second axis of rotation. The first axis and the second axis may intersect and may be perpendicular depending on the embodiment.

In one embodiment of the present invention, the manipulation stage is configured to enable the relative movement between the light source and the detector system via three of more degrees of freedom. This configuration of the manipulation stage may provide for more versatile relative positioning of the light source and the detector system. For example, in one embodiment, the manipulation stage can also include linear positioners for linear positioning along one or more coordinates of a Cartesian coordinate system. For example, the mounting stage can include a linear table, an XY-table or a Z-table or a combination of two or three of these tables to form a multi-axis micro-positioning translation stage that allows the light source to be precisely positioned with respect to the intersection of the first axis of rotation and second axis of rotation. Such an embodiment can enable alignment of a light source such that the detector system retains focus of a specific surface element of the light source while rotating about the first and/or second axis. This also enables the relative orientation between the detector system and the light source to be adequately accurately specified in terms of longitude and latitude coordinates, for example.

Control and Processing System

The control and processing system provides control signals to the manipulation stage for controlling the relative position and orientation between the light source and the detector system. The control and processing system further is configured to process the collected data representative at least in part of the spectroradiometric properties of the light source into photometric and/or colourmetric data representative of the light source. The control and processing system may further optionally control the operating conditions of the light source and the sampling of data performed by the detector system.

The control and processing system includes a computing system for controlling the components of the apparatus and for processing incoming signals and acquired data. The control and processing system can comprise a number of component controllers controlled by the computing system. The computing system can comprise a general purpose or dedicated special computer and can comprise one or more CPUs, a number of different memory devices, input or output or input/output interfaces for interconnecting controllers, optional position sensors included in the manipulation stage, the detector system, optional network interfaces and a user interface system, for example.

The control and processing system includes one or more interfaces for communicating with the actuators and/or motors of the manipulation stage and can provide control signals for the operation of the actuators and/or motors.

In one embodiment of the present invention, certain aspects of the operation of the apparatus may be controlled by the control and processing system in a feed forward, feedback or mixed feed forward feedback manner. For example, actuators and motors are typically controlled in a feed forward way but may optionally include position sensors for detecting certain conditions which may be used for feedback control of the manipulation stage, for example.

In one embodiment, when the manipulation stage includes positioning devices and control devices in the form of an integrated modular unit as provided by, for example, a manufacturer, the control and processing system can include hardware, firmware and/or software for controlling such modular units in accordance with their specifications.

In one embodiment of the present invention, the design of the control and processing system embodies an overall model of the apparatus in order to be able to perform adequate control of the components of the apparatus. For example, the model of the apparatus may be based on the degrees of freedom associated with the manipulation stage for example the positioning devices together with limitations to respective ranges of movement thereof. In addition, the model of the apparatus can include a representation of the detector system and the format of the data which representative of the light source which can be collected by the detector system, thereby providing a means for determining the type and level of data processing that is required in order that the photometric and/or colourmetric characteristics of the light source can be determined.

In one embodiment of the present invention, the control and processing system provides a means for processing the sampled spatial spectroradiometric, photometric or colourmetric data. The control and processing system can optionally determine photometric and/or colourmetric data from spatial spectroradiometric data as indicated. For this purpose the control and processing system can be configured with a data acquisition method in order to acquire spectroradiometric, photometric or colourmetric data at a number of predetermined relative orientations between the light source and detector system within a desired solid angle. The acquisition method can optionally also adaptively determine a number of relative orientations between the light source and detector system at which spectroradiometric, photometric or colourmetric data need to be determined. The acquisition method can adaptively determine relative orientations or coordinates between the light source and detector system by analysing the curvatures, gradient magnitudes or the like of one or more already acquired specroradiometric, photometric or colourmetric properties at certain relative orientations or coordinates that meet a certain predetermined relationship. For example, the sampled orientations or coordinates may be proximate neighbours as defined by the respective relative orientations. Adaptively generated additional orientations or coordinates may be used to acquire and determine spectroradiometric, photometric or colourmetric properties with refined orientational and spatial resolution.

In one embodiment of the present invention, photometric and/or colourmetric properties of light can be analytically determined based on the spectroradiometric properties of the light by, for example, adequate filtering of the light or computational processing of the spectral power distribution (SPD) of the sensed light. Employing high quality optical filters with spectral filter characteristics matching those of the desired vision/observer model, however, may be costly. Certain vision models/observer standards may require using spectral filter characteristics with negative as well as positive sensitivities. For example, this is the case for the red component in the CIE 1931 RGB colour matching functions and this requirement may increase the complexity of the control and processing system design. For example, a single optical filter with a weighting function for the red component of the CIE 1931 RGB model currently does not exist. Instead some form of optical or electronic processing may be required. The apparatus may require a separate filter for each contiguous wavelength range between those wavelengths where the sensitivities of the colour matching functions change in sign. An apparatus with such a predetermined filter design may be limited in flexibility, ruggedness and cost-efficiency but may equally be useful for purposes of the present invention. It is noted that elements with adequate transmission or reflection characteristics corresponding to the desired weighting function can be used as optical filters.

In one embodiment of the present invention, filtering the light electronically entails processing the SPD of adequately resolved spectral data and therefore requires a more complex control and processing system setup with devices capable of spectrally resolving the light. On an overall apparatus level, however, this consideration may be greatly outweighed by significantly enhanced flexibility of the apparatus. Computational determination of photometric and/or colourmetric properties may be performed by for example weighting the SPD with the respective colour matching function and computing the weighted average. It is noted that some pre-processing or post-processing of acquired data may be necessary to determine an adequately calibrated SPD as well as to derive certain colour coordinates such as CIE xy or uv as would be readily understood.

In one embodiment of the present invention, the control and processing system can include a user interface for interaction with a user at least at certain times during operation. The user interface can display desired information about the status of the apparatus or the light source, for example. The user interface can include input means to enter user data representative of desired operating conditions or ranges of operating conditions of the components of the apparatus or the light source, for example.

In one embodiment of the present invention, the control and processing system can process the user input data. The user input data can include information for programming a predetermined way of automatically acquiring spectroradiometric, photometric or colourmetric data for various apparatus configurations. Programmable control and processing system configurations can include sequences of longitudes and latitudes or planar coordinates for orientations of the manipulation stage as well as the operating conditions of the light source, for example.

The invention will now be described with reference to specific examples. It will be understood that the following examples are intended to describe embodiments of the invention and are not intended to limit the invention in any way.

### EXAMPLES

FIG. 1 schematically illustrates an apparatus 100 according to an embodiment of the present invention. The apparatus comprises a manipulation stage 110 with two rotational degrees of freedom for manipulating the orientation of light source 190.

The apparatus further comprises a control system 140 which comprises a motor controller 142 and a processing system 144. The motor controller 142 controls the actuators or motors M_{y} 122 and M_{z} 124 in accordance with instructions received from the processing system 144. The motor controller 142 can report status information regarding the condition or position of the actuators or motors 122 and 124 to the processing system 144. The processing system can control the operating conditions of the light source 190. The apparatus further comprises a detector system 150 which can be configured to collect radiometric data. The detector system 150 can be configured in a number of different ways including a probe 152, multi-channel detector (not illustrated) or spectrometer 154, for example. The detector system can comprise one or more detector elements which can be configured linearly or in an areal matrix-like fashion or in any other ways well known in the art.

The control system 140 is operatively connected to the detector system 150 with which it can exchange control and data signals. The detector system can provide information regarding acquired spectroradiometric data such as the spectral power distribution of the sensed light. The detector system can optionally comprise means to directly provide photometric or colourmetric data. Moreover, the detector system can provide information about the operational conditions of the probe or detector, for example. The detector system can comprise a collimation system comprising, for example, one or more slits or apertures for controlling the light receiving solid angle and for collimating light. The probe can comprise an adequately shaped end of an optic fiber or a bundle of optic fibers, for example. The probe may comprise a light receiving integrating sphere.

In one embodiment of the present invention motor M_{y} can be a Newport RV160PP or similar precision rotation stage, motor M_{z} can be a RTM160PP or similar precision rotation stage, and the motor controller can be a Newport ESP300, for example. The spectrometer can be an Instrument Systems CAS140B or similar device with a fiber-optic interface connected to an adequate optical probe.

It is noted that many manipulation stages which are equipped with up to two rotation stages and a plan-parallel translation stage can offer rotation capabilities within a half circle range. Manipulation stages with close to half circle rotation capabilities for each of two perpendicular axes can greatly aid in implementing embodiments of the present invention which are suitable for characterizations of light sources for other than far-field conditions. It is noted that characterizations of light sources which are conducted under other than far-field conditions may require types of probes other than the ones which are useful for characterizations under far-field conditions.

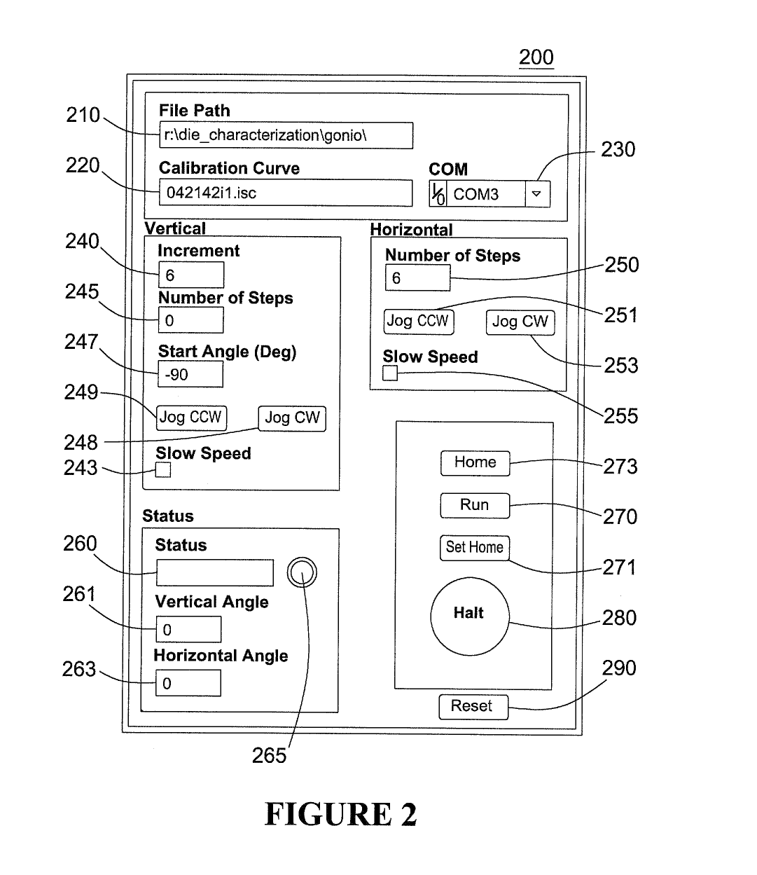

FIG. 2 illustrates an embodiment of a portion 200 of the user interface according to one embodiment of the present invention. The user interface can additionally display (not illustrated) one, two, or three dimensional graphs of positions and orientations of the light source as well as acquired and processed data including CCT, CRI, L, (x,y), (u,v) etc. The graphs may be displayed and updated as new data becomes available while measurements are ongoing. As illustrated, the user interface can display or query information about control parameters such as: the “File Path” 210 which identifies a file into which the acquired data may be saved and under “Calibration Curve” 220, an indication of the desired calibration data for calibrating any acquired radiometric or photometric data. Calibration of the data can account for certain dispersion effects in the transmission of light, for example, along the optical-fiber or the sensitivity of sensor elements. Further control parameters can include which serial port 230 to use for controlling the motor controller, the vertical angle increment (in degree) 240 by which the vertical angle of the M_{z} rotation of the manipulation stage is increased during programmed automatic data acquisition, and the number of steps (increments) 245 of the vertical angle. Furthermore the user interface can display or query the vertical start angle 247 at which to start a programmed automatic data acquisition as well as control elements 248 and 249 such as buttons, for example, for changing the vertical angle in a counter clockwise (jog CCW) or clockwise (jog CW) direction, and an element 243 for choosing a “Slow Speed” when changing the vertical angle.

The user interface can include a number of elements for displaying or affecting the horizontal angle of the My rotation of the manipulation stage. As illustrated these can include the number of steps (increments) 250 of the horizontal angle, as well as jogging the horizontal angle either counter clockwise 251 or clockwise 253, and for choosing a slow speed 255 for changing the horizontal angle.

As illustrated, further elements of the user interface can include a status message under the “Status” field 260, indicating the status or providing an indication of the operating conditions of the apparatus. Moreover, “Vertical Angle” 261 and “Horizontal Angle” 263 display the current angles of rotation of the manipulation stage. An indicator element 265 next to the “Status” field, for example can turn red or flash red, in order to signal that the apparatus is undergoing reconfiguration, for example, a rotation motor of the manipulation stage is turning to reconfigure the apparatus. A signalling indicator element can also indicate that the apparatus can currently not accept any further input or another reconfiguration request.

As is further illustrated there can be a user interface element “Run” 270 for initiating a scan as configured by the settings under “Vertical” and “Horizontal”. Furthermore there can be a “Set Home” element 271 for defining a predetermined home configuration of the manipulation stage and a “Home” element 273 for putting the apparatus into that predetermined home configuration. For example, the home configuration can be defined as a null (zero) angle of rotation of the manipulation stage. The null angle can refer to a hardware coded or a previously defined software coded configuration of the manipulation stage. The user interface can have a “Halt” element 280, useful, for example, for emergency purposes. Activating the “Halt” element can, for example, stop all movement of the manipulation stage and any other mechanical component of the apparatus. Furthermore, a “Reset” element 290 can be used to reset all entry fields to a default value and optionally reconfigure the apparatus, for example.

In addition, the size of the apparatus depends on the type of light source that is intended to be investigated. An apparatus for the characterization of a relatively small light source, for example the size of a light bulb, can be significantly smaller than those intended for the characterization of a luminaire.

Furthermore, different types of light sources may require different types of attachment methods or mechanisms. Light sources can be releasably attached to the manipulation stage in a number of different ways. For example, the attachment can include a mounting stage suitable for mounting a luminaire, a LED or LED die or any other type of light-emitting element. The format and type of attachment can further comprise means such as a barrel, for example, for reproducibly disposing a light source.

In particular, distances to the light source can vary depending on the type of probe and the type of detector. For example according to one embodiment and as illustrated in FIG. 1, the manipulation stage comprises one horizontal rotation stage 120 for rotation about the y-axis and a vertical rotation stage 130 for rotation about the z-axis. It is noted that the manipulation stage can comprise one or more additional rotation or translation stages. For example, one or more additional translation stages can greatly aid in the initial set-up of the apparatus specifically for the proper alignment of the light source.

As already generally described above, another embodiment of the present invention can comprise a rotational stage for rotating the light source about a first axis of rotation and another rotation stage for rotating the detector system or a portion thereof, for example solely the probe, about a second axis of rotation. The first and the second axis of rotation can intersect at or proximate the light source and can include a normal angle.

In another embodiment of the present invention, the apparatus comprises one or more plan-parallel translation stages for translational movement of the detector system, probe, detector or array, matrix or grid of probes or detector elements.

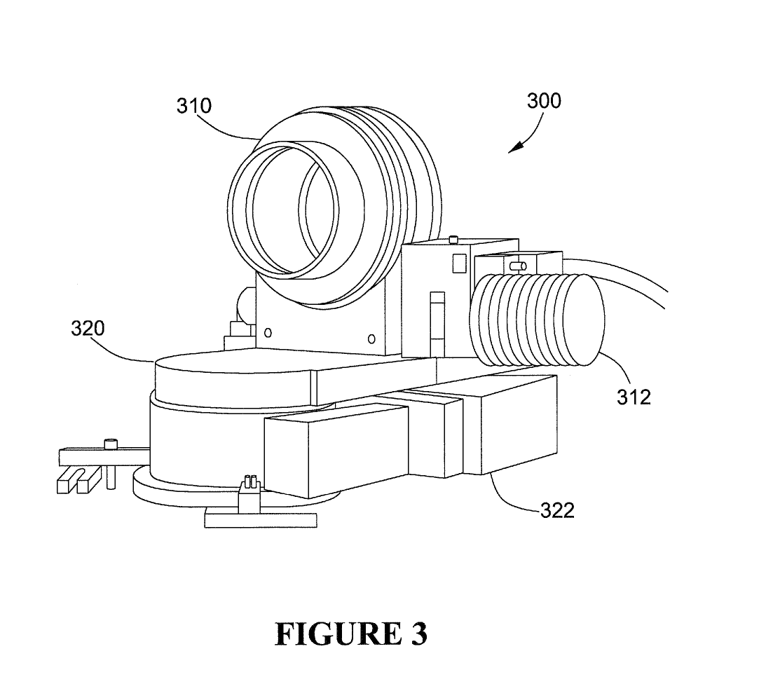

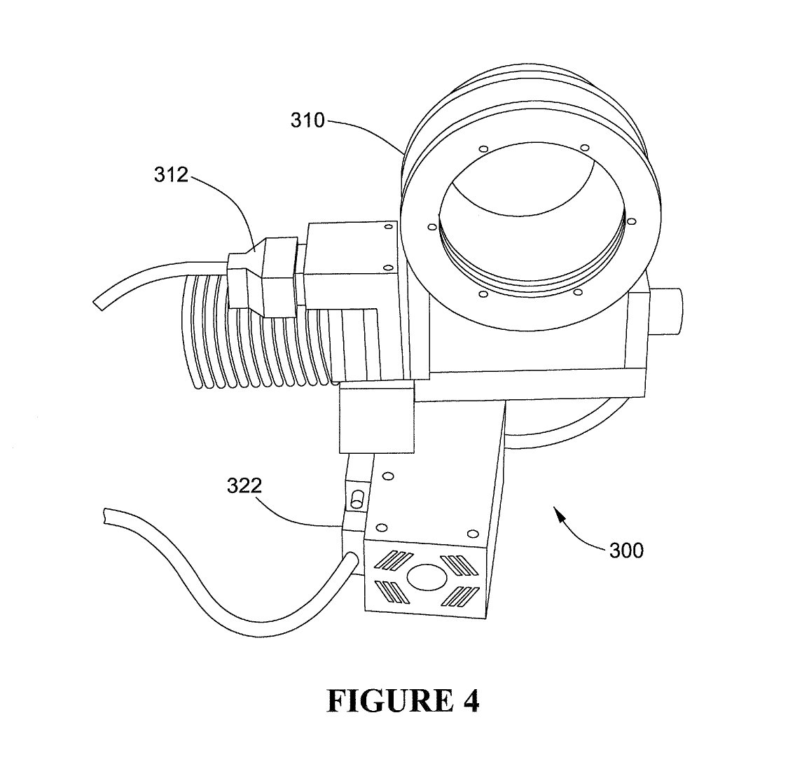

FIG. 3 and FIG. 4 illustrate photos of a manipulation stage 300 for an apparatus for characterizing a light source according one embodiment of the present invention. Manipulation stage 300 comprises a rotation stage 310 with motor drive 312 and a rotation stage 320 with motor drive 322.

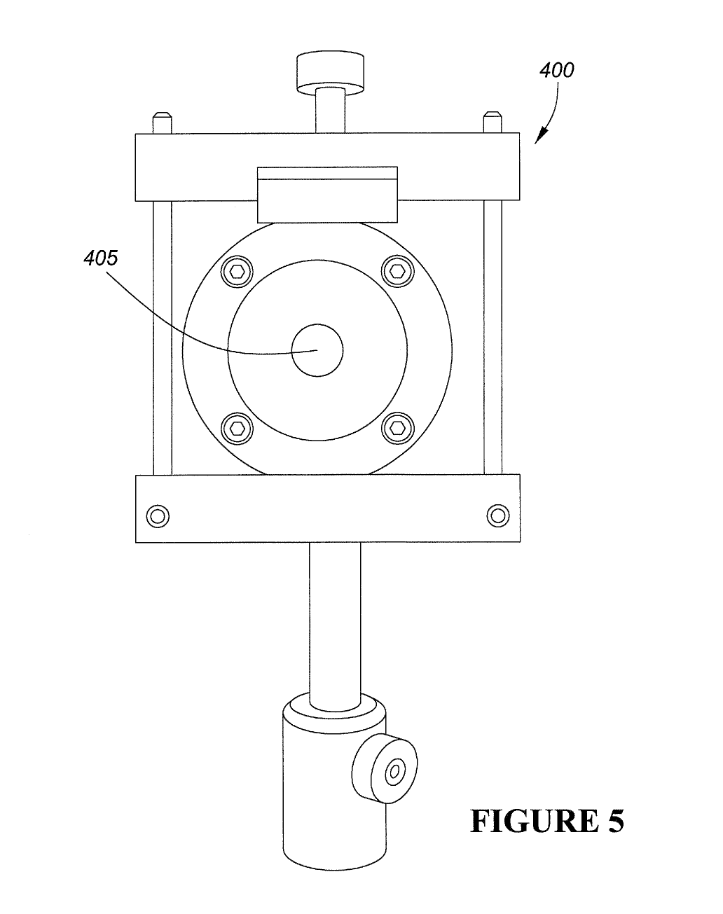

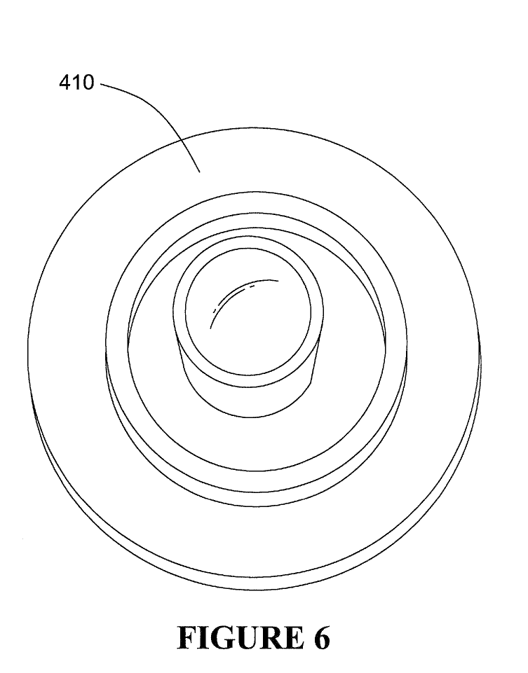

FIG. 5 illustrates a photo of a probe support 400 with a probe alignment element 405 for aligning a probe (not illustrated) for an apparatus for characterizing a light source according one embodiment of the present invention. FIG. 6 illustrates a photo of a front view of a probe 410. The probe support illustrated in FIG. 5 provides for modular setup of the probe, for example, on an optical table.

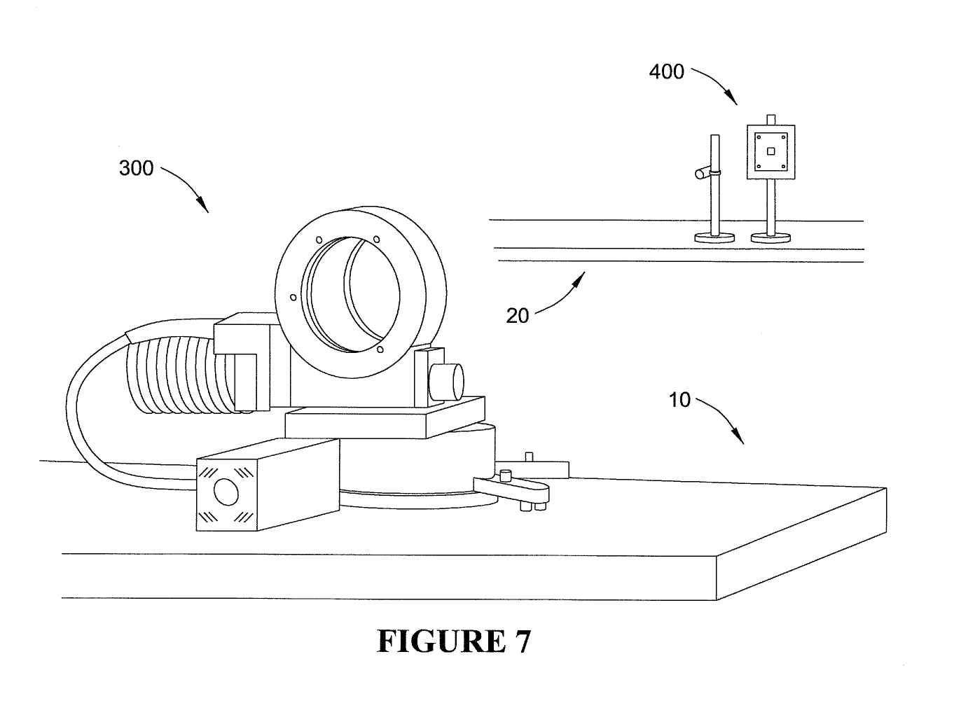

FIG. 7 illustrates a photo of a prototype set-up of an apparatus for characterizing a light source according to one embodiment of the present invention. It comprises manipulation stage 300 and probe support 400. The manipulation stage 300 is disposed on an optical bench 10, and operatively attached to a control system (not illustrated) and a power supply (not illustrated). The manipulation stage can hold a light source (not illustrated). The probe support comprises a probe which is also operatively connected. The probe support is disposed on a wall shelf 20. The apparatus is set-up in a room with adequate dark room characteristics. Calibration of the set-up can comprise one or more steps for relative positioning and orientation of the optical bench 10 relative to wall shelf 20, for example.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. An apparatus for determining properties of light emitted by a light source, the apparatus comprising:
a) a detector system for generating data indicative of at least spectroradiometric data for at least a portion of the light emitted by the light source,
b) a manipulation stage configured to control relative position between the detector system and the light source; and
c) a control and processing system configured to control operation of the detector system and operation of the manipulation stage, the control and processing system further configured to record the data and the relative position of the detector system and the light source associated therewith, the control and processing system configured to process the data for determination of the photometric or colourmetric properties of the light emitted by the light source.

2. The apparatus according to claim 1, wherein the control and processing system is configured to process the data for determination of the photometric and colourmetric properties of the light emitted by the light source.

3. The apparatus according to claim 1, wherein the manipulation stage has two or more degrees of freedom for positioning the detector system or the light source.

4. The apparatus according to claim 1, comprising a user interface for programming the control and processing system.

5. The apparatus according to claim 4, wherein the user interface can be used to enter control parameters.

6. The apparatus according to claim 1, wherein the detector system and the light source can be independently positioned.

7. The apparatus according to claim 1, comprising a probe operatively connected to the detector system for collecting light.

8. The apparatus according to claim 1, wherein the detector system comprises a spectrometer.

9. The apparatus according to claim 1, wherein the detector system comprises a multi-channel detector.

10. The apparatus according to claim 1, wherein detector system includes a filtering system configured to at least in part provide the photometric or colourmetric properties of the light emitted by the light source.

11. The apparatus according to claim 10, wherein the filtering system is configured based on the CIE 1931 model.

12. A method for determining properties of light emitted by a light source, the method comprising the steps of:
a) disposing and aligning the light source relative to a coordinate system;
b) positioning a detector system at a sensor position distal to the light source thereby defining a relative position and orientation between the detector system and the light source, the detector system generating at least spectroradiometric data of at least a portion of the light emitted by the light source;
c) acquiring spectroradiometric data from the detector system;
d) manipulating the spectroradiometric data to produce photometric or colourmetric data indicative of the acquired spectroradiometric data.

13. The method according to claim 12, wherein the step of manipulating enables determination of photometric and colourmetric data indicative of the acquired spectroradiometric data.

14. The method according to claim 12 further comprising recording the spectroradiometric data and the relative position and orientation between the detector system and the light source in a data repository.

15. The method according to claim 12 further comprising recording the photometric or colourmetric data and the relative position and orientation between the detector system and the light source in a data repository.

16. The method according to claim 12 further comprising determining a new orientation and position of the light source.

17. The method according to claim 16, wherein the new orientation and position can be entered via a user interface.

18. The method according to claim 16, wherein the new orientation and position is selected from a plurality of predetermined orientations and positions.
